(19) United States
(12) Patent Application Publication
(10) Pub. No.: US 2003/0052909 A1
(43) Pub. Date: Mar. 20, 2003

(54) Real-time rendering of edited video stream

(75) Inventors: Shaojun Mo, Zhejian (CN); Rusong Fang, Zhejian (CN); Qinggen Chen, Fremont, CA (US)

Correspondence Address: Patent Law Group LLP, Suite 223, 2635 North First Street, San Jose, CA, 95134, US

(73) Assignee: ArcSoft, Inc.

(21) Appl. No.: 10/177,237

(22) Filed: Jun. 21, 2002

Related U.S. Application Data
(63) Continuation-in-part of application No. 09/891,613, filed on Jun. 25, 2001.

(51) Int. Cl. G09G 5/00

(52) U.S. Cl. 345/716

(57) ABSTRACT

A method for video editing software to display a preview of a video in real-time includes (a) retrieving one or more frames to be displayed at a current time into a system RAM of a computer; (b) applying one or more effects to the one or more frames to form a new frame; (c) displaying the new frame on a monitor without saving the new frame on a storage medium of the computer; and (d) repeating the actions (a) to (c) for subsequent times. The method may include reducing the resolution of the one or more frames after retrieving the one or more frames. The displaying of the new frame on a screen may include using a multimedia programming interface, such as DirectX, to copy the new frame in the system RAM to a RAM of a display card of the computer and using the multimedia programming interface to refresh the display card to display on a monitor the new frame.

### CROSS-REFERENCE TO RELATED APPLICATION

This application is a continuation-in-part of U.S. application Ser. No. 09/891,613, entitled “Method and Apparatus for Real-Time Rendering of Edited Video Stream,” filed Jun. 25, 2001, which is incorporated herein by reference.

### FIELD OF THE INVENTION

This invention relates to systems and methods for displaying video images in real-time.

### DESCRIPTION OF RELATED ART

Several video editing software packages for home and business computers are available to the public. These packages allow users to process, order, and merge video clips and still images, add transitions and special effects render changes, and display results on a computer screen.

Of particular interest is how the prior art packages render the changes. “To render” means to process requested effects and then present them on a monitor or screen to a user or observer. A limiting factor in the prior art is that rendering is performed as a batch process. In a batch process, user requests are collected, stored, and then executed upon command. This usually means that the user or observer must wait to view a completed video until the batch rendering is complete.

Therefore, there is a need for providing real-time rendering of video images.

### SUMMARY OF THE INVENTION

In one embodiment, a method for video editing software to display a preview of a video in real-time includes (a) retrieving one or more frames to be displayed at a current time into a system RAM of a computer; (b) applying one or more effects to the one or more frames to form a new frame; (c) displaying the new frame on a monitor without saving the new frame on a storage medium of the computer; and (d) repeating the actions (a) to (c) for subsequent times. In one embodiment, the method further includes reducing the resolution of the one or more frames after retrieving the one or more frames. In one embodiment, the displaying of the new frame on a screen includes using a multimedia programming interface to copy the new frame in the system RAM to a RAM of a display card of the computer and using the multimedia programming interface to refresh the display card to display on a monitor the new frame. The multimedia programming interface is, e.g., DirectX from Microsoft.

### BRIEF DESCRIPTION OF THE DRAWINGS

FIG. 1 is a block drawing of a system for providing real-time rendering of a series of video clips and still images according to one preferred embodiment of the present invention.

FIG. 2 is a flow chart of the steps performed by a processor implementing the function of real-time rendering according to one preferred embodiment of the present invention.

FIG. 3 is a flow chart of the steps performed by a processor implementing the main function of real-time rendering according to the computer source code in Listing 1.

FIGS. 4, 5, and 6 are flow charts of the steps performed by a processor implementing the checkplay function of real-time rendering according to the computer source code in Listing 1.

FIGS. 7A and 7B illustrate a flowchart of a method for video editing software to render a video in real-time in one embodiment.

FIG. 8 illustrates a computer with various software and hardware components used in the method of FIGS. 7A and 7B in one embodiment.

### DETAILED DESCRIPTION

The following description is of the best presently contemplated modes of carrying out the invention. This description is made for the purpose of illustrating the general principles of the invention and is not to be taken in a limiting sense.

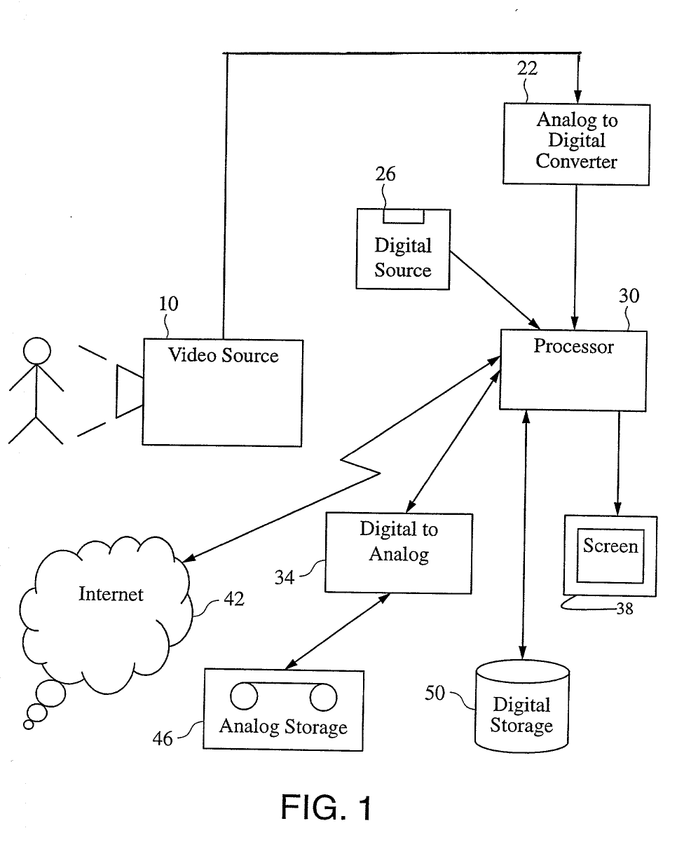

FIG. 1 illustrates a preferred embodiment of a system of real-time rendering of video data. From a video source 10 (such as a camera) video images may be sent via a video transmitter 14 over communications link 16 to an analog to digital converter 22 before passing to processor 30. If video is available from a digital source 26, video may proceed directly to processor 30.

Processor 30 may store and retrieve data and video on digital storage 50. Processor 30 executes user instructions, made available from a variety of sources such as a mouse and a keyboard (not shown). Processor 30 may then send video output to any of a variety of destinations. For example, it may send a real-time video stream to a screen 38. Or it may send video to a digital to analog converter 34 and onto analog storage 46 (e.g., video tape for use with a VCR). Processor 30 may also forward video output to a communications link for transmission via the Internet 42, for example.

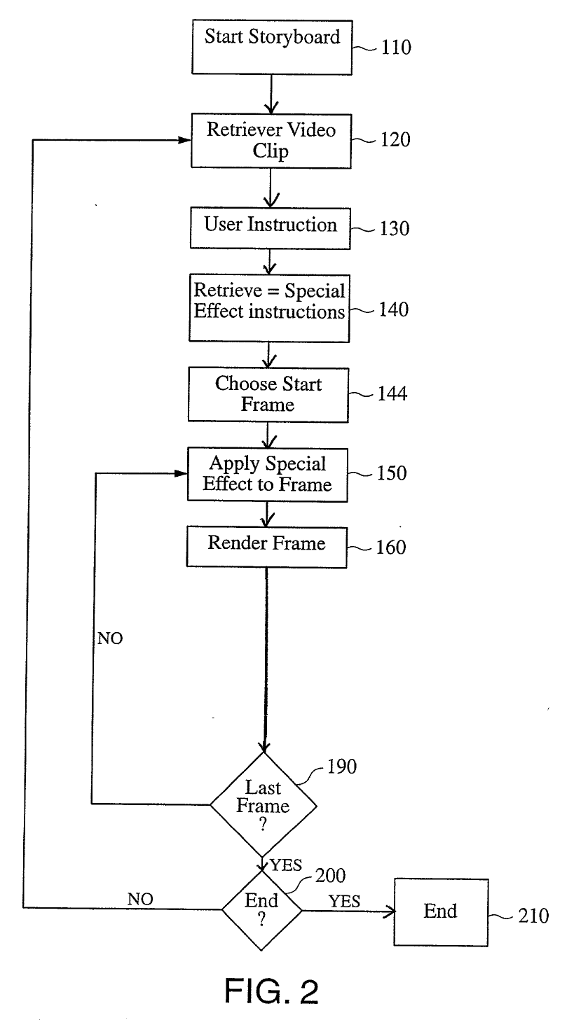

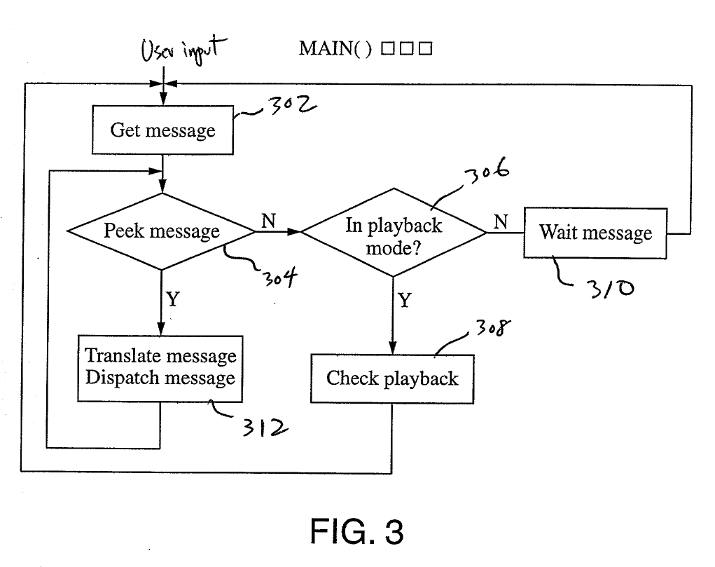

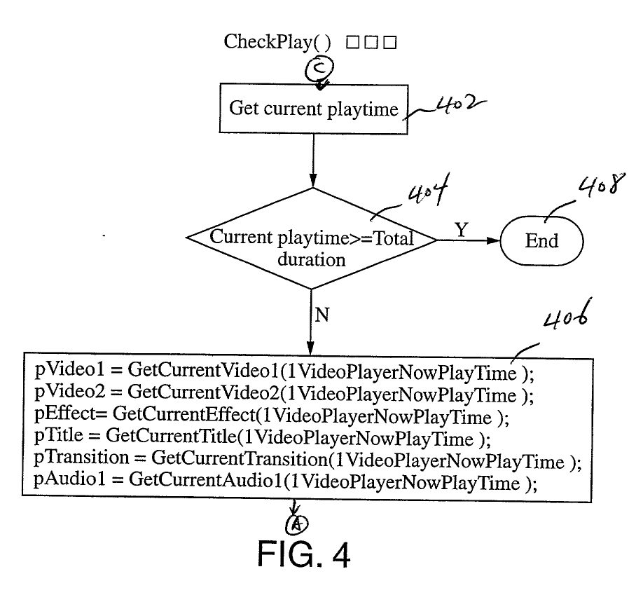

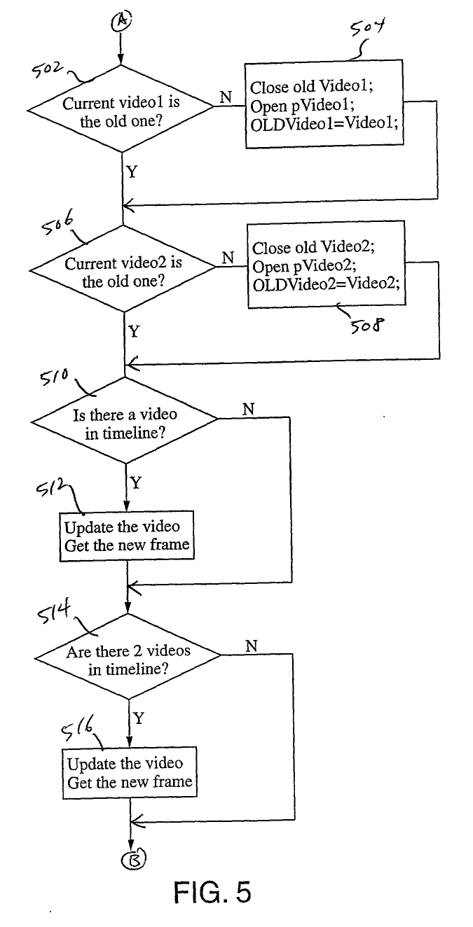

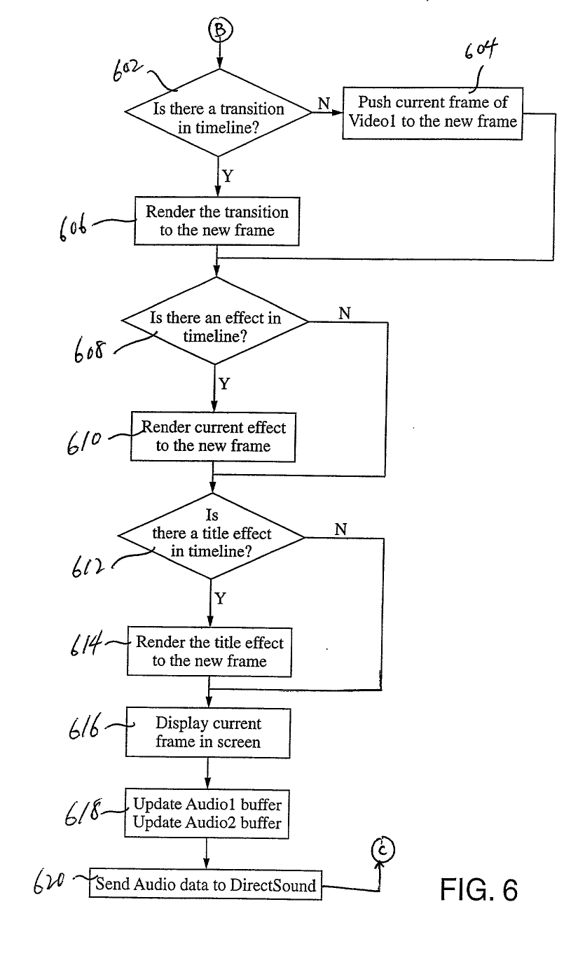

FIG. 2 illustrates a preferred embodiment of a process of real-time rendering of a video. Upon initiating video editing program, a storyboard is set up in action 110. Then a video clip is retrieved in action 120, preferably from storage 50. While the video clip may consist of a still, frequently it will comprise a number of images each of which is termed a frame. Based upon user instruction in action 130, special effect instructions are retrieved in action 140. These effects may include text, audio, video frames or transition frame effects. A start frame of the retrieved video clip is chosen in action 144. Special effects, if any, are applied to a frame in action 150. The frame is rendered and displayed in action 160 to an observer. If this is not the last frame of the video clip in action 190, then the process iterates to action 150. If this is not the last video clip of the video in action 200, a new video clip is retrieved in action 120. Otherwise the process ends in action 210.

Listing 1 is computer source code of a main function and a checkplay function implementing an alternative embodiment of a process of real-time rendering of video data.

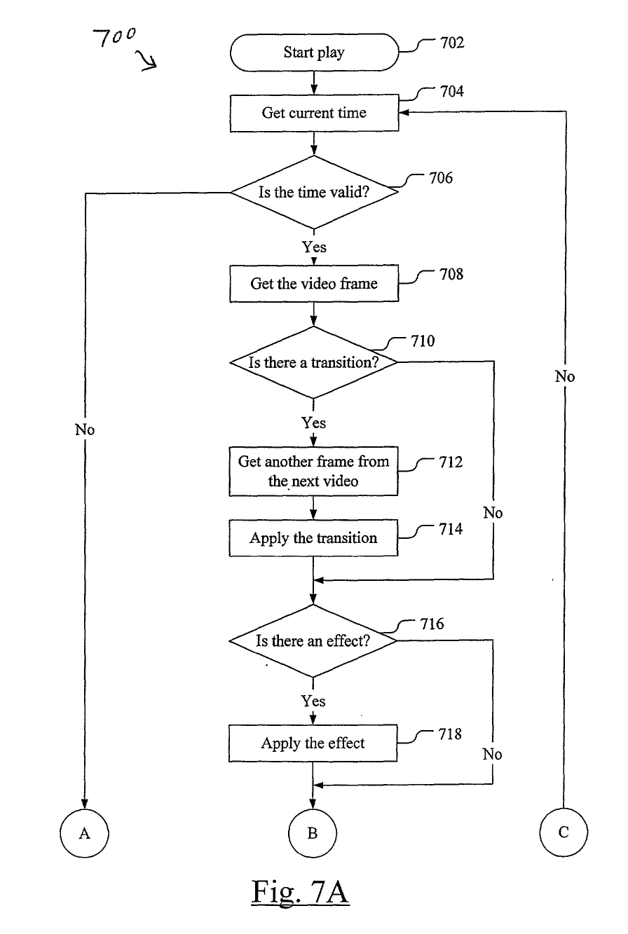

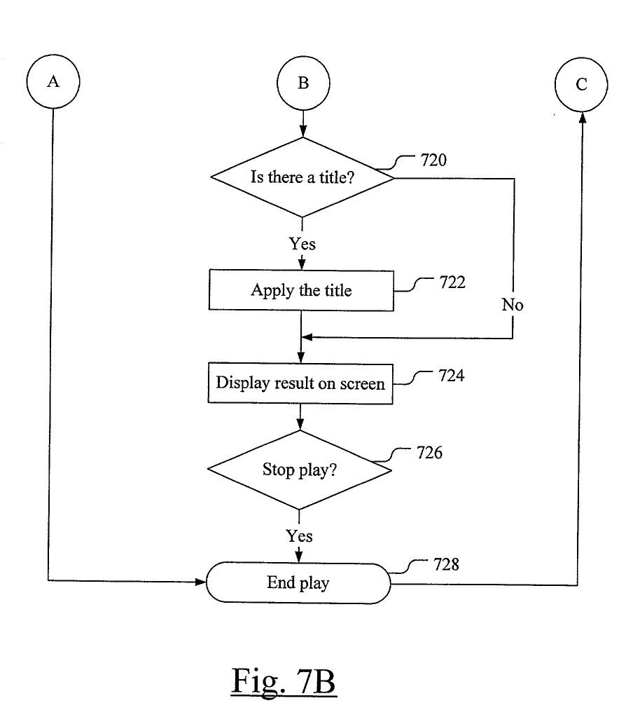

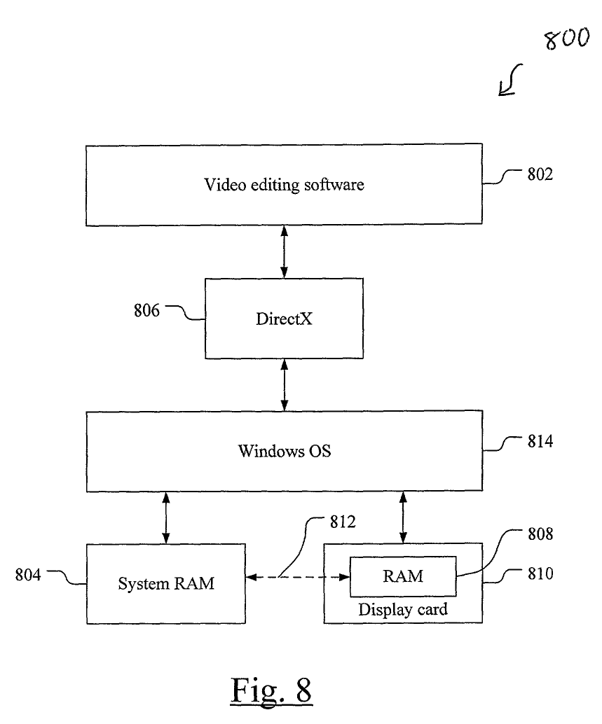

FIGS. 7A and 7B illustrate a flowchart of a method 700 for video editing software 802 (FIG. 8) to render a video in real-time in one embodiment. Video editing software 802 displays the video in a small window (e.g., 360 by 240 pixels) for a real-time preview. The video usually consists of multiple video clips arranged in a sequential manner by the user. In the video, a preceding video clip and a subsequent video clip can have overlapping frames in time. The preceding video clip is hereafter referred to as “the current video clip” while the subsequent video clip is referred to as “the next video clip”. The edited video also usually includes transition effects, special effects, and title/text effects selected by the user.

In action 702 (FIG. 7A), video editing software 802 receives an input from the user to play the video. In action 704, video editing software 802 starts a timer and gets the current time. The current time is used to retrieve one or more frames of the video clips at an appropriate rate for display. In one embodiment, the display rate is 1/20 second. Thus, video editing software 802 must apply effects to the frame, send the frame to a video display card, and have the video display card display the frame on a monitor within 1/20 second. Experimental results are described later.

In action 706, video editing software 802 determines if the current time is valid. The current time is valid if it is less than or equal to the duration of the entire video. If the current time is valid, action 706 is followed by action 708. Otherwise action 706 is followed by action 728 (FIG. 7B) that ends method 700.

In action 708, video editing software 802 retrieves a frame at the current time from a current video clip. Typically the frame is stored in high resolution (e.g., 1280 by 1024 pixels). Accordingly, video editing software 802 may reduce the frame to low resolution (e.g., 360 by 240 pixels) for a real-time preview of the video. Video editing software 802 typically puts this frame in a system RAM (random access memory) 804 (FIG. 8) of computer 800.

In action 710, video editing software 802 determines if there is a transition at the current time between the current video clip and the next video clip. In other words, video editing software 802 determines if the current and the next video clips have overlapping frames at the current time. If so, action 710 is followed by action 712. If there is not a transition, action 710 is followed by action 716.

In action 712, video editing software 802 retrieves a frame at the current time from the next video clip. As described above, video editing software 802 may reduce the frame to low resolution. Video editing software 802 typically retrieves this frame into system RAM 804.

In action 714, video editing software 802 applies the transition effect to the frames from the current and the next video clips to form a new frame. Transition effects include wipes, fade, dissolves, and innovative page turns. Video editing software 802 stores the new frame in system RAM 804.

In action 716, video editing software 802 determines if there is a special effect to be applied to the new frame. If so, action 716 is followed by action 718. If there is no special effect to be applied to the new frame, action 716 is followed by action 720.

In action 718, video editing software 802 applies the special effect to the new frame. Special effects include mosaic, rain drops, film grain, shake, multiply, horizontal hold. Video editing software 802 stores the new frame in system RAM 804. In one embodiment, the algorithms for applying special effects can be written in assembly language to utilize the hardware more efficiently.

In action 720 (FIG. 7B), video editing software 802 determines if there is a title/text effect to be applied to the new frame. If so, action 720 is followed by action 722. If there is no title/text effect to be applied to the new frame, action 720 is followed by action 724.

In action 722, video editing software 802 applies the title/text effect to the new frame. Title/text effects include titles and credits. Video editing software 802 stores the new frame in system RAM 804.

In action 724, video editing software 802 displays the new frame on the screen. In one embodiment, video editing software 802 uses DirectX 806 (FIG. 8) to copy the new frame in system RAM 804 to a DirectDraw surface in a RAM 808 (FIG. 8) of a display card 810 (FIG. 8) in computer 800. The transfer of new frame data between system RAM 804 and display card RAM 808 by DirectX 806 is symbolized by arrow 812 (FIG. 8). Video editing software 802 then uses DirectX 806 to refresh display card 810 to display on a monitor the new frame generated on the fly as described above. DirectX is a conventional component of the Microsoft Windows operating system 814 (FIG. 8) that provides low level communication between application software and hardware.

In conventional video editing software, all the frames are processed and then stored on a storage medium (e.g., a hard drive) before they are displayed in a batch procedure. In embodiments of method 700, each frame is processed, stored in system RAM, and then displayed immediately to the user without waiting for the remainder of the frames. In embodiments of method 700, the frames are not stored on a storage medium before they are displayed. Action 724 is followed by action 726.

In action 726, video editing software 802 determines if it receives user input to stop playing the edited video. If so, action 726 is followed by action 728 that ends method 700. If video editing software 802 does not need to stop playing the edited video, action 726 is followed by action 702 (FIG. 7A) and method 700 cycles as described above.

As described above, video editing software 802 must process and display each frame within 1/20 second (i.e., 50 milliseconds) for the video preview to appear in real-time to the user. The time for processing and displaying one frame is estimated to be approximately 50 ms for (1) a method 700 using a frame size of 360 by 240 pixels for the video preview, and (2) a system 800 with a Pentium III 300 MHz processor and 64 MB of system RAM. The estimated total time for processing one frame includes (a) 8 ms to retrieve two frames; (b) 10 ms to apply a transition effect; (c) 10 ms to apply a special effect; (d) 10 ms to apply a title/text effect; (e) 3 ms to display a frame; and (f) 9 ms for other logical processes and memory transfer.

Various other adaptations and combinations of features of the embodiments disclosed are within the scope of the invention. Numerous embodiments are encompassed by the following claims.

LISTING 1

main ()
{

for (;;) // get windows message looply.
{

while(PeekMessage(&msg, MULL, 0, 0, PM_REMOVE))
{

TranslateMessage(&msg);

DispatchMessage(&msg);
}
if (g_nPlayStatus==STATUS_PLAYING) //if in playback mode

CheckPlay();

else

WaitMessage();

}

}
BOOL CheckPlay()
{

1VideoPlayerNowPlayTime = timeGetTime () − m_1WindowStartTime +

m_1MediaStartTime;

if (1VideoPlayerNowPlayTime >= M_1ChainTotTime) //if current time past

the total duration of video clips.

{

//end.

}
pVideo1 = GetCurrentVideo1(1VideoPlayerNowPlayTime); // get current

video from timeline

pVideo2 = GetCurrentVideo2(1VideoPlayerNowPlayTime);
pEffect = GetCurrentEffect (1VideoPlayerNowPlayTime);
pTitle = GetCurrentTitle(1VideoPlayerNowPlayTime);
pTransition = GetCurrentTransition(1VideoPlayerNowPlayTime);
pAudio1 = GetCurrentAudio1(1VideoPlayerNowPlayTime.);
pAudio2 = GetCurrentAudio2(1VideoPlayerNowPlayTime);
if (pVideo1 != oldVideo1) //if current video is not the old one, that

means the old one is finished.

{

close old Video1;
open pVideo1;
Old Video1=Video1;

}
if (pVideo2 != oldVideo2)
{

close old Video2;
open pVideo2;
OldVideo2=Video2;

}
if (pVideo1) // if there is a video in timeline
{

pVideo1−>Update(); // update the video, get the new frame from

video file 1.

}
if (pVideo2) //it-there are 2 videos in timeline
{

pVideo2−>Update(); // update the video, get the new frame from

video file 2.

}
if (pTransition) // if there is transition in timeline
{

pNewFrame=RenderTransition(pVideo1,pVideo2,pTransition); // render

transition effect of video! and video2 to new frame.

}else

pNewFrame=pVideo1.currentFrame; //push current frame of Video1 to

pNewFrame;

if (p Effect)
{

pNewFrame = RenderEffect(pNewFrame,pEffect); // render current

effect to new frame

}
if (pTitle) //if there is title effect in timeline
{

pNewFrame = RenderTitle(pNewFrame,pTitle);

}
ShowCurrentFrame(pNewFrame); // display current frame in screen.
PlayBackSegmentOfAudio(); // update audio buffers and render them to

directsound.
}

What is claimed is:

1. A method for video editing software to display a preview of a video in real-time, comprising:
(a) retrieving one or more frames to be displayed at a current time into a system RAM of a computer;
(b) applying one or more effects to the one or more frames to form a new frame;
(c) displaying the new frame on a monitor without saving the new frame on a storage medium of the computer; and
(d) repeating the actions (a) to (c) for subsequent times.

2. The method of claim 1, wherein:
the one or more frames comprises a first frame from a first video clip and a second frame from a second video clip; and
the one or more effects comprises a transition effect that forms the new frame from the first and the second frames.

3. The method of claim 1, wherein the one or more effects comprises a special effect that forms the new frame.

4. The method of claim 1, wherein the one or more effects comprises a title effect that forms the new frame.

5. The method of claim 1, further comprising reducing the resolution of the one or more frames after action (a) and before action (b).

6. The method of claim 1, wherein said displaying the new frame on a screen comprises:
using a multimedia programming interface to copy the new frame in the system RAM to a RAM of a display card of the computer; and
using the multimedia programming interface to refresh the display card to display on a monitor the new frame.

7. The method of claim 6, wherein the multimedia programming interface is DirectX.

8. The method of claim 1, wherein the storage medium is a hard drive of the computer.

9. A method for video editing software to display a preview of a video in real-time, comprising:
(a) if there is a transition between a first video clip and a second video clip at a current time:
(i) retrieving a first frame from the first video clip and a second frame from the second video clip into a system RAM of a computer;
(ii) applying a transition effect to the first and the second frames to form a new frame;
(b) if there is a special effect at the current time, applying the special effect to the new frame;
(c) if there is a title effect, applying the title effect to the new frame;
(d) using a multimedia programming interface to copy the new frame in the system RAM to a RAM of a display card of the computer;
(e) using the multimedia programming interface to refresh the display card to display on a monitor the new frame; and
(f) repeating the actions (a) to (e) for subsequent times.

10. The method of claim 9, wherein the multimedia programming interface is DirectX.

11. The method of claim 9, further comprising reducing the resolution of the first and the second frames after action (a) and before action (b).
